(19) United States
(12) Patent Application Publication
(10) Pub. No.: US 2014/0069229 A1
(43) Pub. Date: Mar. 13, 2014

(54) BIKE EXTENDABLE CRANK

(71) Applicant: Shun-Jie CHANG, Taichung City (TW)

(72) Inventor: Shun-Jie CHANG, Taichung City (TW)

(21) Appl. No.: 13/611,562

(22) Filed: Sep. 12, 2012

(51) Int. Cl. B62M 3/02

(52) U.S. Cl. 74/594.1

(57) ABSTRACT

A bike extendable crank includes an extendable crank unit. The extendable crank unit includes an immovable crank and a movable crank. The immovable crank has a slide trough therein, a limit groove at one side thereof and a main axle hole above the limit groove. One end of the movable crank has a first pivot hole for connection of a pedal and another end of the movable crank has a second pivot hole for connection a guide axle. The movable crank is slidably received in the slide trough of the immovable crank. The guide axle inserting through the second pivot hole of the movable crank slides in the limit groove of the immovable crank.

### BACKGROUND OF THE INVENTION

1. Field of the Invention

The present invention relates to a bike extendable crank, and more particularly, to a bike extendable crank which is labor-saving to drive the bike.

2. Description of the Prior Art

The length of a conventional bike crank is immovable. For saving labor, the length of the crank can be lengthened. But, the rotation speed becomes slow because the circumference diameter is increased. If there is a bump on the road, the crank may collide with the bump to cause an accident. For a high-speed rotation, the crank can be shortened to reduce the circumference diameter. However, it is laborious. A long crank can save labor, but the rotation speed is low. A short crank can provide a high-speed rotation, but it is laborious. Accordingly, the inventor of the present invention has devoted himself based on his many years of practical experiences to solve these problems.

### SUMMARY OF THE INVENTION

The primary object of the present invention is to provide a bike extendable crank which comprises at least one extendable crank unit and at least one cam unit. Each extendable crank unit comprises an immovable crank and a movable crank. The immovable crank has a slide trough therein, a limit groove at one side thereof, and a main axle hole above the limit groove. One end of the movable crank has a first pivot hole for connection of a pedal, and another end of the movable crank has a second pivot hole for connection a guide axle. The movable crank is slidably received in the slide trough of the immovable crank. The guide axle inserting through the second pivot hole of the movable crank slides in the limit groove of the immovable crank. The cam unit comprises a support, a retainer, an inner cam and an outer cam. The support has a pivot hole. At least two supports are connected to the retainer. The outer cam has a track guide trough therein and an outer cam track at the edge of the track guide trough. The inner cam has a guide hole. The inner cam has an inner cam track at a circumferential edge thereof. The inner cam track is less than the outer cam track of the track guide trough. At least two outer cams are respectively connected to two sides of the support. The inner cam is disposed in the track guide trough of the outer cam and connected to the support. The inner cam track of the inner cam and the outer cam track of the outer cam form a cam track. The retainer of the cam unit is pivotally connected to the seat pipe of the bike frame. The main axle of the bike frame is pivotally connected with the gear. The main axle is inserted through the pivot hole of the support and the guide hole of the inner cam and connected to the main axle hole of the immovable crank of the extendable crank unit. The guide axle of the movable crank slides within the cam track formed between the inner cam track of the inner cam and the outer cam track of the outer cam. By driving the extendable crank unit, the guide axle of the movable crank slides relative to the cam track between the inner cam and the outer cam so that the movable crank and the immovable crank extends and retracts relative the crank track for control of the length of the extendable crank unit. When the extendable crank unit is turned to an angle which needs applying a force, the movable crank will extend relative to the immovable crank. When the extendable crank unit is turned to an angle which doesn't need applying a force, the movable crank will retract relative to the immovable crank to shorten the diameter so as to increase the rotation speed. In this way, it is labor-saving and quick to ride the bike.

### BRIEF DESCRIPTION OF THE DRAWINGS

FIG. 1 is a perspective view showing an extendable crank unit and a cam unit according to a preferred embodiment of the present invention;

FIG. 2 is a perspective view showing the extendable crank unit according to the preferred embodiment of the present invention;

FIG. 3 is an exploded view showing an immovable crank and a movable crank according to the preferred embodiment of the present invention;

FIG. 4 is a schematic view showing the extendable crank unit, the cam unit and a bike frame according to the preferred embodiment of the present invention;

FIG. 5 is a top view showing the extendable crank unit and the cam unit according to the preferred embodiment of the present invention;

FIG. 6 is a front view showing the cam unit and the bike frame according to the preferred embodiment of the present invention;

FIG. 7 is a rear view showing the cam unit and the bike frame according to the preferred embodiment of the present invention;

FIG. 8 is a schematic showing a cam track between an inner cam and an outer cam according to the preferred embodiment of the present invention;

FIG. 9 is a schematic showing operation of a guide axle of the extendable crank unit relative to the cam track of the cam unit and extension of the extendable crank unit according to the preferred embodiment of the present invention; and

FIG. 10 is a schematic showing the cam track between the inner cam and the outer cam relative to the guide axle of the extendable crank unit according to the preferred embodiment of the present invention.

### DETAILED DESCRIPTION OF THE PREFERRED EMBODIMENTS

Embodiments of the present invention will now be described, by way of example only, with reference to the accompanying drawings.

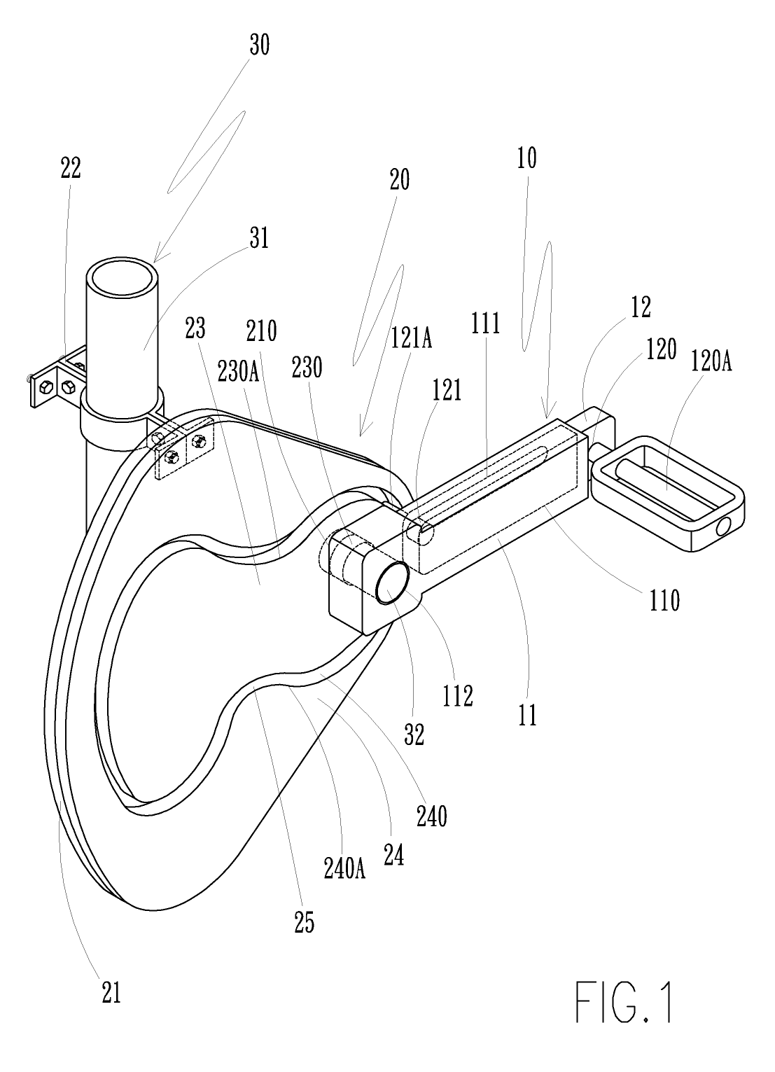

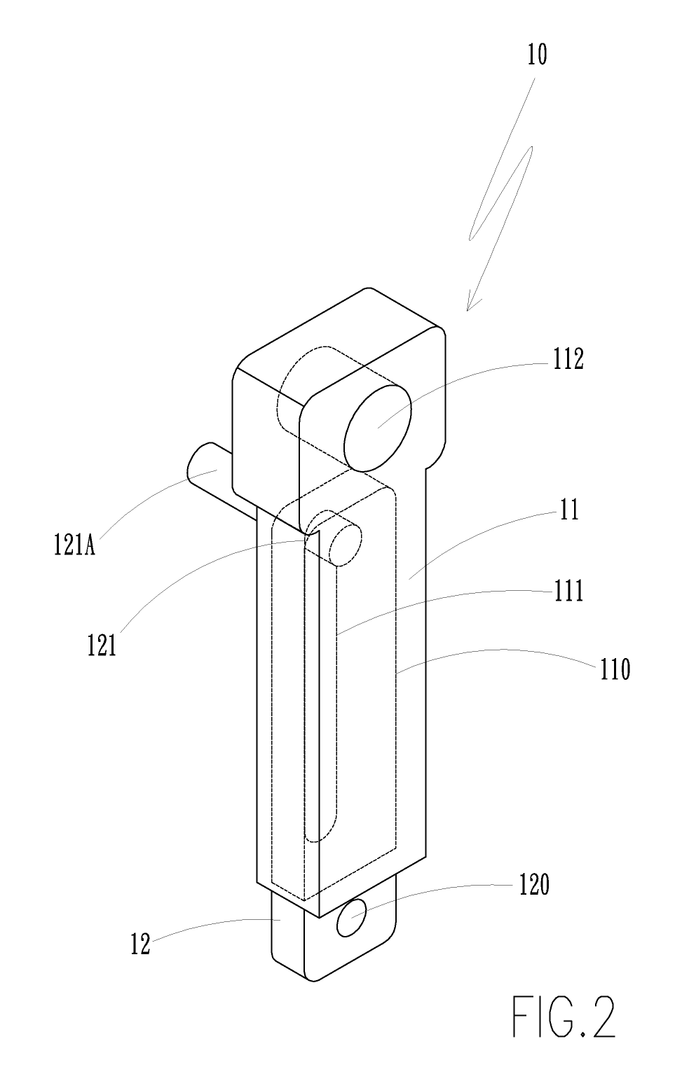

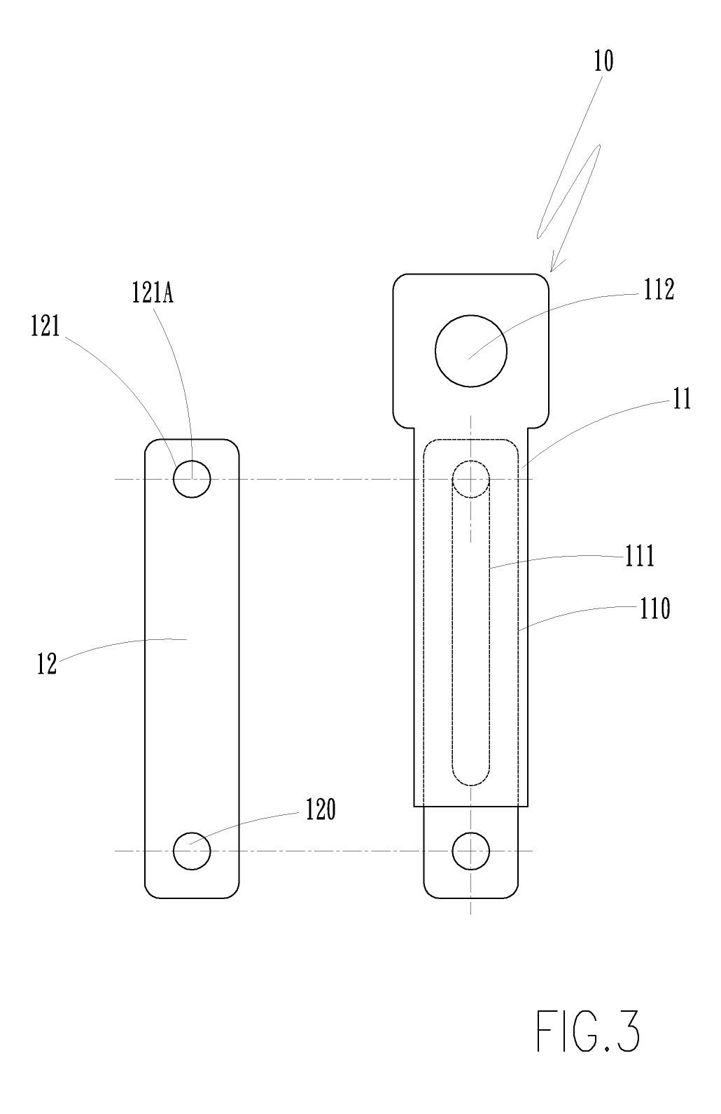

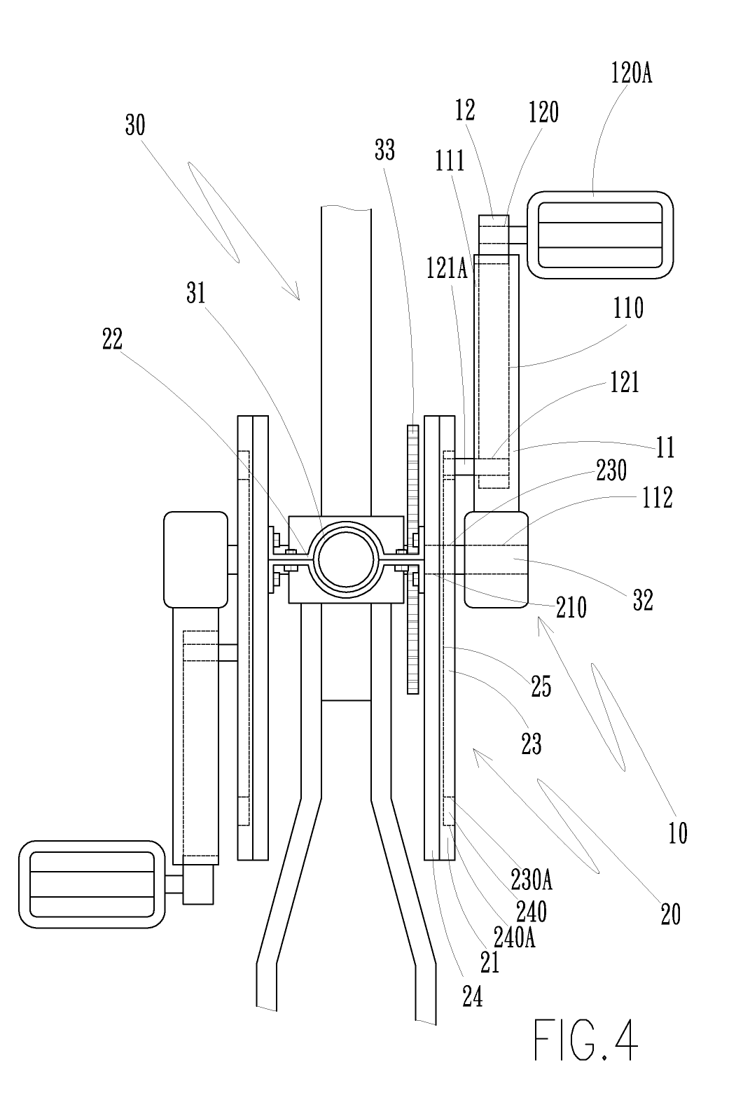

FIG. 1 is a perspective view showing an extendable crank unit and a cam unit according to a preferred embodiment of the present invention. FIG. 2 is a perspective view showing the extendable crank unit according to the preferred embodiment of the present invention. FIG. 3 is an exploded view showing an immovable crank and a movable crank according to the preferred embodiment of the present invention. FIG. 4 is a schematic view showing the extendable crank unit, the cam unit and a bike frame according to the preferred embodiment of the present invention. The present invention comprises at least one extendable crank unit (10), at least one cam unit (20) and a bike frame (30).

The extendable crank unit (10) comprises an immovable crank (11) and a movable crank (12). The immovable crank (11) has a slide trough (110) therein, a limit groove (111) at one side thereof, and a main axle hole (112) above the limit groove (111). One end of the movable crank (12) has a first pivot hole (120) for connection of a pedal (120A), and another end of the movable crank (12) has a second pivot hole (121) for connection a guide axle (121A). The movable crank (12) is slidably received in the slide trough (110) of the immovable crank (11). The guide axle (121A) inserting through the second pivot hole (121) of the movable crank (12) slides in the limit groove (111) of the immovable crank (11).

The cam unit (20) comprises a support (21), a retainer (22), an inner cam (23) and an outer cam (24). The support (21) has a pivot hole (210). At least two supports (21) are connected to the retainer (22). The outer cam (24) has a track guide trough (240) therein and an outer cam track (240A) at the edge of the track guide trough (240). The inner cam (23) has a guide hole (230). The inner cam (23) has an inner cam track (230A) at a circumferential edge thereof. The inner cam track (230A) is less than the outer cam track (240A) of the track guide trough (240). At least two outer cams (24) are respectively connected to two sides of the support (21). The inner cam (23) is disposed in the track guide trough (240) of the outer cam (24) and connected to the support (21). The inner cam track (230A) of the inner cam (23) and the outer cam track (240A) of the outer cam (24) form a cam track (25). The cam track (25) between the inner cam (23) and the outer cam (24) is adapted for the guide axle (121A) of the movable crank (12) of the extendable crank unit (10) to slide therein.

The bike frame (30) comprises a seat pipe (31) and a main axle (32) pivotally connected with a gear (33). The seat pipe (31) is pivotally connected with the retainer (22) of the cam unit (20). The main axle (32) is inserted through the pivot hole (210) of the support (21) and the guide hole (230) of the inner cam (23) and connected to the main axle hole (112) of the immovable crank (11) of the extendable crank unit (10). Thus, the assembly of the bike extendable crank of the present invention is completed.

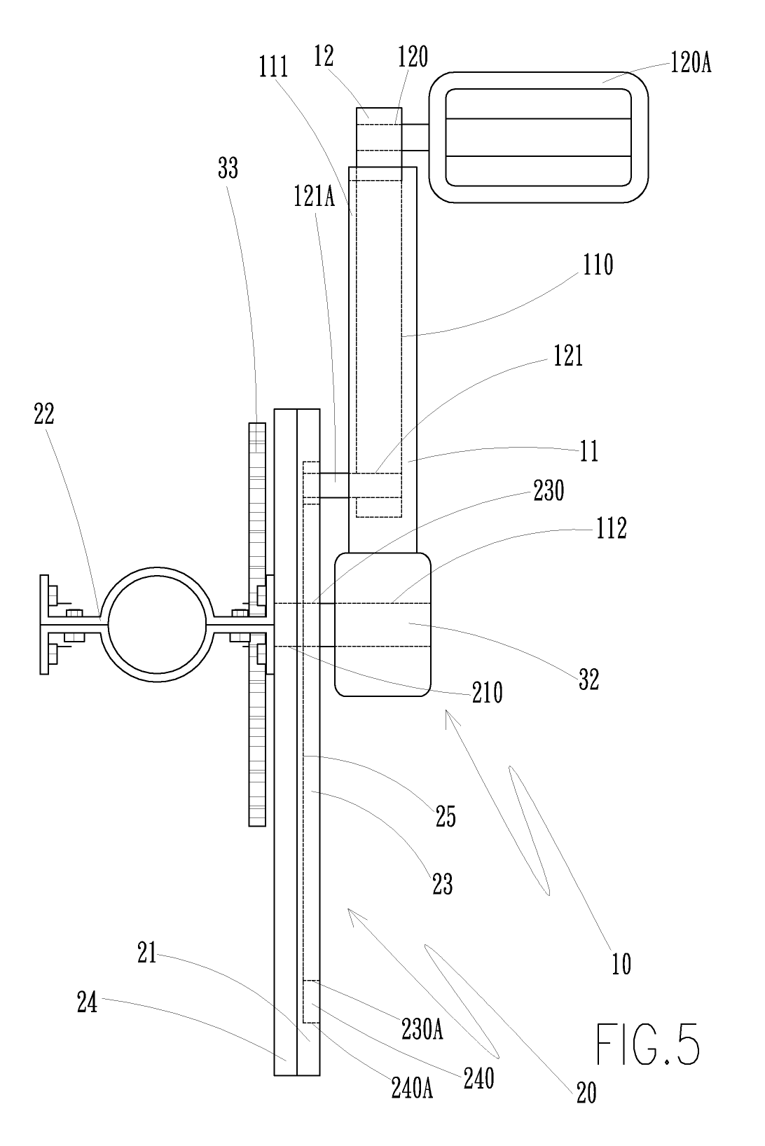

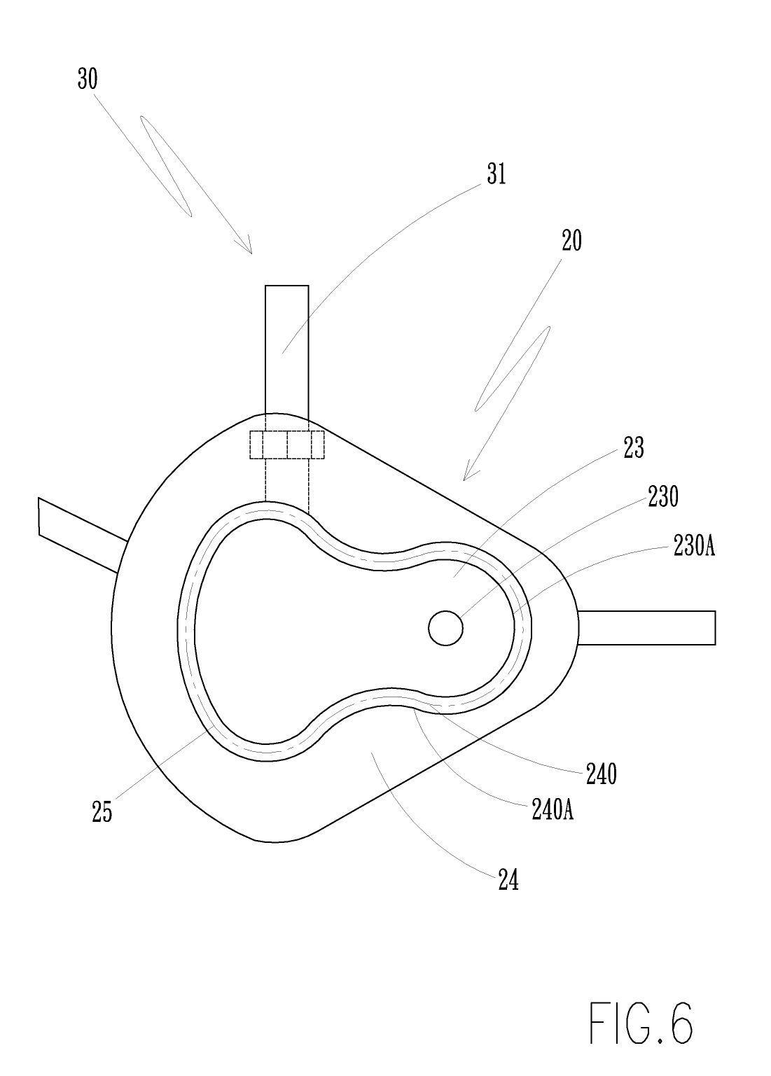

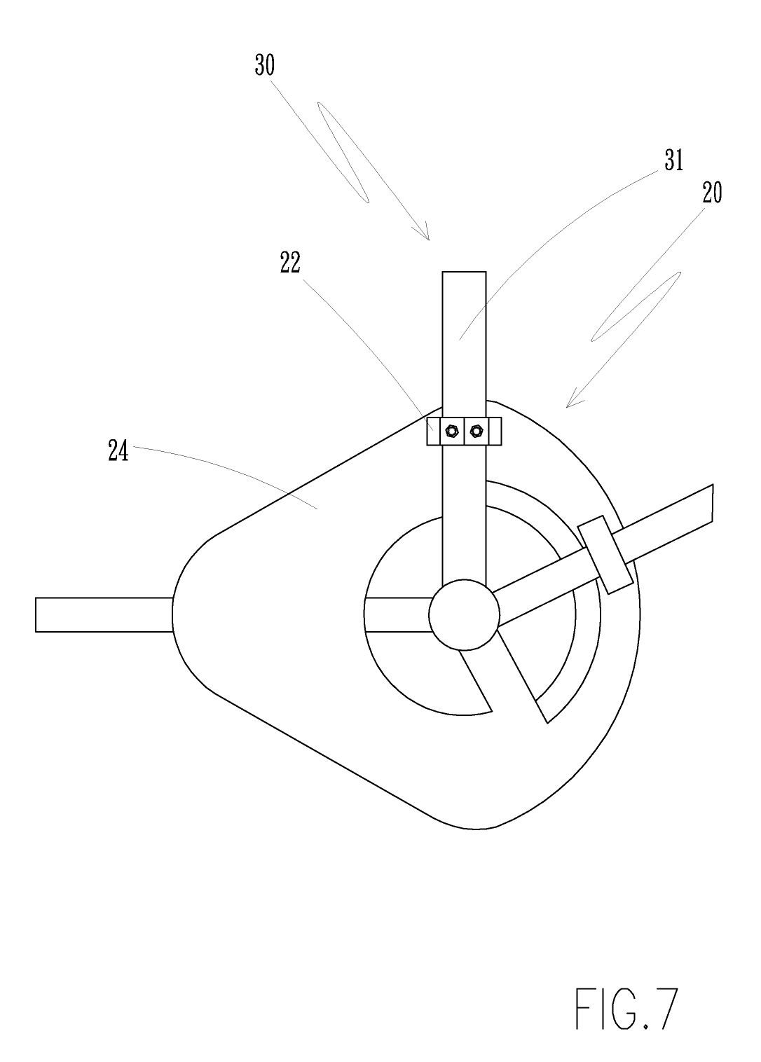

FIG. 1 is a perspective view showing the extendable crank unit and the cam unit according to a preferred embodiment of the present invention. FIG. 2 is a perspective view showing the extendable crank unit according to the preferred embodiment of the present invention. FIG. 3 is an exploded view showing the immovable crank and the movable crank according to the preferred embodiment of the present invention. FIG. 4 is a schematic view showing the extendable crank unit, the cam unit and the bike frame according to the preferred embodiment of the present invention. FIG. 5 is a top view showing the extendable crank unit and the cam unit according to the preferred embodiment of the present invention. FIG. 6 is a front view showing the cam unit and the bike frame according to the preferred embodiment of the present invention. FIG. 7 is a rear view showing the cam unit and the bike frame according to the preferred embodiment of the present invention. The retainer (22) of the cam unit (20) is pivotally connected to the seat pipe (31) of the bike frame (30). The main axle (32) of the bike frame (30) is pivotally connected with the gear (33). The main axle (32) is inserted through the pivot hole (210) of the support (21) and the guide hole (230) of the inner cam (23) and connected to the main axle hole (112) of the immovable crank (11) of the extendable crank unit (10). The guide axle (121A) of the movable crank (12) slides within the cam track (25) formed between the inner cam track (230A) of the inner cam (23) and the outer cam track (240A) of the outer cam (24). By driving the extendable crank unit (10), the guide axle (121A) of the movable crank (12) slides relative to the cam track (25) between the inner cam (23) and the outer cam (24) so that the movable crank (12) and the immovable crank (11) extends and retracts relative the crank track (25) for control of the length of the extendable crank unit (10). When the extendable crank unit (10) is turned to an angle which needs applying a force, the movable crank (12) will extend relative to the immovable crank (11). When the extendable crank unit (10) is turned to an angle which doesn't need applying a force, the movable crank (12) will retract relative to the immovable crank (11) to shorten the diameter so as to increase the rotation speed. In this way, it is labor-saving and quick to ride the bike.

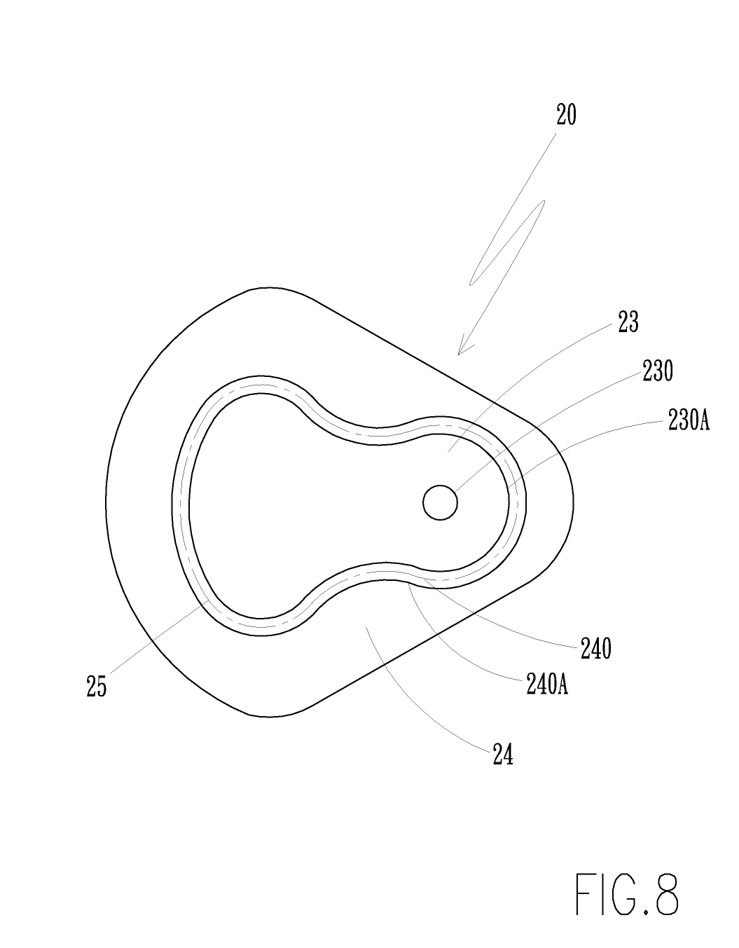

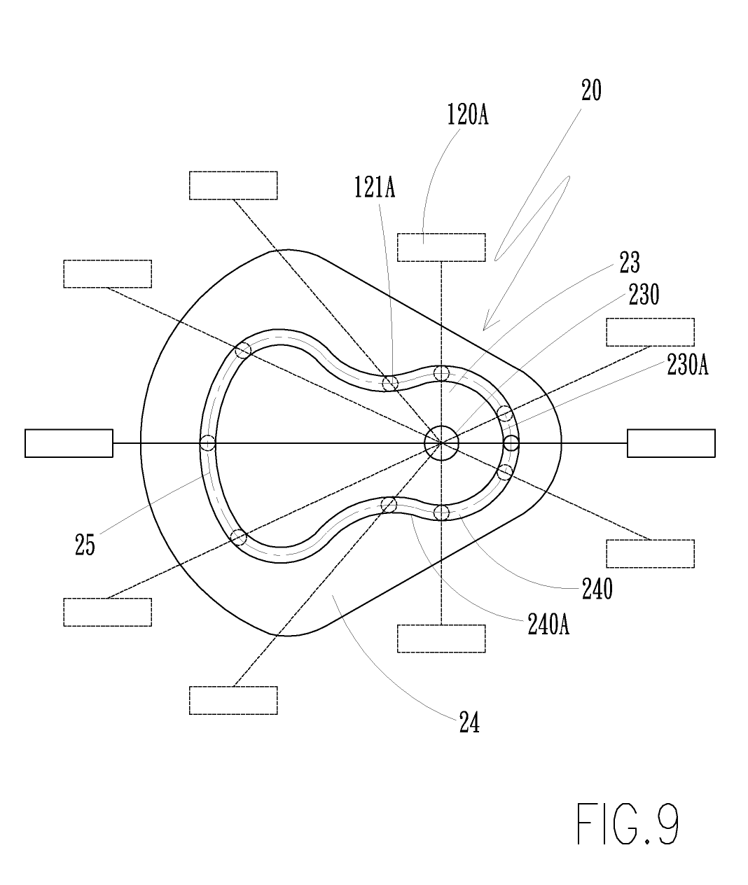

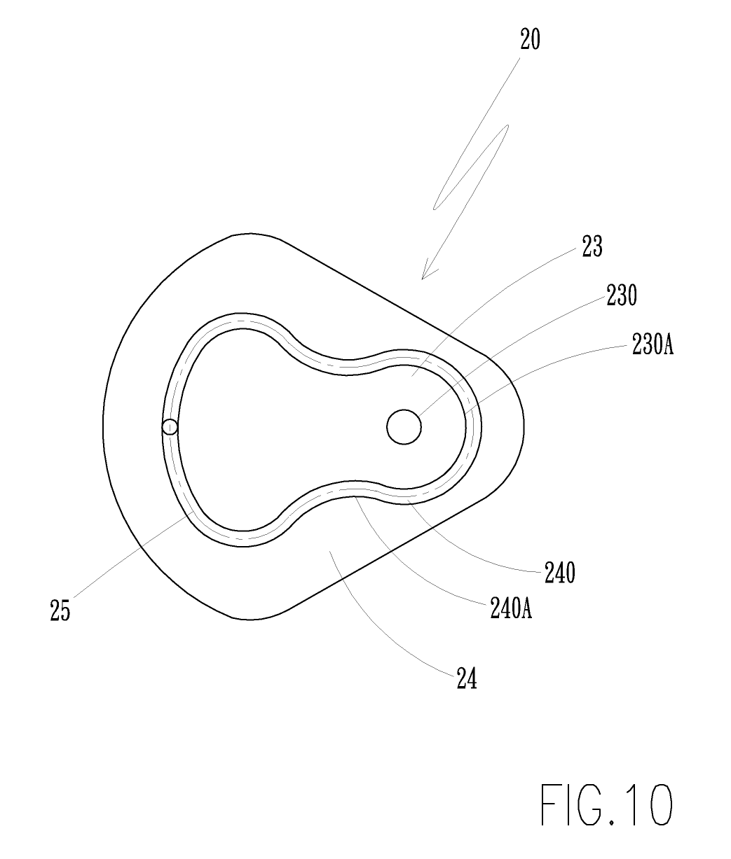

FIG. 8 is a schematic showing the cam track between the inner cam and the outer cam according to the preferred embodiment of the present invention. FIG. 9 is a schematic showing operation of the guide axle of the extendable crank unit relative to the cam track of the cam unit and extension of the extendable crank unit according to the preferred embodiment of the present invention. FIG. 10 is a schematic showing the cam track between the inner cam and the outer cam relative to the guide axle of the extendable crank unit according to the preferred embodiment of the present invention. The cam track (25) is disposed between the outer cam track (240A) of the track guide trough (240) of the outer cam (24) and the inner cam track (230A) of the inner cam (23). The movable crank (12) of the extendable crank unit (10) extends through the outer cam crank (240) of the outer cam (24). The inner cam crank (230A) of the inner cam (23) is to steady the length of the movable crank (12). When the extendable crank unit (10) moves along the inner cam track (230A), the movable crank (12) retracts and outer cam (24) is to steady the length of the movable crank (12).

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A bike extendable crank, comprising:
an extendable crank unit, the extendable crank unit comprising an immovable crank and a movable crank, the immovable crank having a slide trough therein, a limit groove at one side thereof and a main axle hole above the limit groove, one end of the movable crank having a first pivot hole for connection of a pedal and another end of the movable crank having a second pivot hole for connection a guide axle, the movable crank being slidably received in the slide trough of the immovable crank, the guide axle inserting through the second pivot hole of the movable crank sliding in the limit groove of the immovable crank.

2. A bike extendable crank, comprising:
an extendable crank unit, the extendable crank unit comprising an immovable crank and a movable crank, the immovable crank having a slide trough therein, a limit groove at one side thereof and a main axle hole above the limit groove, one end of the movable crank having a first pivot hole for connection of a pedal and another end of the movable crank having a second pivot hole for connection a guide axle, the movable crank being slidably received in the slide trough of the immovable crank, the guide axle inserting through the second pivot hole of the movable crank sliding in the limit groove of the immovable crank; and
a cam unit, the cam unit comprising a support, an inner cam and an outer cam, the support having a pivot hole, the outer cam having a track guide trough therein and an outer cam track at an edge of the track guide trough, the inner cam having a guide hole, the inner cam having an inner cam track at a circumferential edge thereof, the inner cam track being less than the outer cam track of the track guide trough, the outer cam being connected to an outer side of the cam unit, the inner cam being disposed in the track guide trough of the outer cam and connected to the cam unit, the inner cam track of the inner cam and the outer cam track of the outer cam forming a cam track, the cam track between the inner cam and the outer cam being adapted for the guide axle of the movable crank of the extendable crank unit to slide therein.

3. A bike extendable crank, comprising:
at least two extendable crank units, each extendable crank unit comprising an immovable crank and a movable crank, the immovable crank having a slide trough therein, a limit groove at one side thereof and a main axle hole above the limit groove, one end of the movable crank having a first pivot hole for connection of a pedal and another end of the movable crank having a second pivot hole for connection a guide axle, the movable crank being slidably received in the slide trough of the immovable crank, the guide axle inserting through the second pivot hole of the movable crank sliding in the limit groove of the immovable crank;
at least two cam units, each the cam unit comprising a support, a retainer, an inner cam and an outer cam, the support having a pivot hole, at least two supports being connected to the retainer, the outer cam having a track guide trough therein and an outer cam track at an edge of the track guide trough, the inner cam having a guide hole, the inner cam having an inner cam track at a circumferential edge thereof, the inner cam track being less than the outer cam track of the track guide trough, at least two outer cams being respectively connected to two sides of the support, the inner cam being disposed in the track guide trough of the outer cam and connected to the support, the inner cam track of the inner cam and the outer cam track of the outer cam forming a cam track, the cam track between the inner cam and the outer cam being adapted for the guide axle of the movable crank of the extendable crank unit to slide therein; and
a bike frame, the bike frame comprising a seat pipe and a main axle pivotally connected with a gear, the seat pipe being pivotally connected with the retainer of the cam unit, the main axle being inserted through the pivot hole of the support and the guide hole of the inner cam and connected to the main axle hole of the immovable crank of the extendable crank unit.
